(19) United States
(12) Patent Application Publication
(10) Pub. No.: US 2024/0215081 A1
(43) Pub. Date: Jun. 27, 2024

(54) BEARER TRAFFIC SECURITY ENFORCEMENT USING TRAFFIC POLICY INFORMATION

(71) Applicant: QUALCOMM Incorporated, San Diego, CA (US)

(72) Inventors: Akshaya DOGRA, San Diego, CA (US); Rajashekar CHILLA, San Diego, CA (US); Swati SHARMA, San Diego, CA (US); Sadaf AHAMED, San Diego, CA (US)

(21) Appl. No.: 18/145,532

(22) Filed: Dec. 22, 2022

(51) Int. Cl. H04W 76/10; H04W 28/02

(52) U.S. Cl. CPC H04W 76/10; H04W 28/0236

(57) ABSTRACT

Various aspects of the present disclosure generally relate to wireless communication. In some aspects, an apparatus may establish a protocol data unit (PDU) session on a bearer. The apparatus may receive a packet in the PDU session. The apparatus may forward the packet based at least in part on whether traffic descriptor (TD) information in the packet matches TD information obtained from traffic policy information. Numerous other aspects are described.

### FIELD OF THE DISCLOSURE

Aspects of the present disclosure generally relate to wireless communication and to techniques and apparatuses for bearer traffic security enforcement using traffic policy information.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by an apparatus of a wireless device. The method may include establishing a protocol data unit (PDU) session on a bearer. The method may include receiving a packet in the PDU session. The method may include forwarding the packet based at least in part on whether traffic descriptor (TD) information in the packet matches TD information obtained from traffic policy information.

Some aspects described herein relate to an apparatus of a wireless device configured for wireless communication. The apparatus may include a memory and one or more processors coupled to the memory. The one or more processors may be configured to establish a PDU session on a bearer. The one or more processors may be configured to receive a packet in the PDU session. The one or more processors may be configured to forward the packet based at least in part on whether TD information in the packet matches TD information obtained from traffic policy information.

Some aspects described herein relate to a non-transitory computer-readable medium that stores a set of instructions for wireless communication by an apparatus of a wireless device. The set of instructions, when executed by one or more processors of the apparatus, may cause the wireless device to establish a PDU session on a bearer. The set of instructions, when executed by one or more processors of the apparatus, may cause the wireless device to receive a packet in the PDU session. The set of instructions, when executed by one or more processors of the apparatus, may cause the wireless device to forward the packet based at least in part on whether TD information in the packet matches TD information obtained from traffic policy information.

Some aspects described herein relate to an apparatus for wireless communication. The apparatus may include means for establishing a PDU session on a bearer. The apparatus may include means for receiving a packet in the PDU session. The apparatus may include means for forwarding the packet based at least in part on whether TD information in the packet matches TD information obtained from traffic policy information.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram of an example of a core network configured to provide network slicing.

FIG. 5 is a diagram illustrating an example associated with session establishment, in accordance with the present disclosure.

FIG. 6 is a diagram illustrating an example of bearer security, in accordance with the present disclosure.

FIG. 7 is a diagram illustrating an example process performed, for example, by an apparatus of a wireless device, in accordance with the present disclosure.

FIG. 8 is a diagram of an example apparatus for wireless communication, in accordance with the present disclosure.

FIG. 9 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

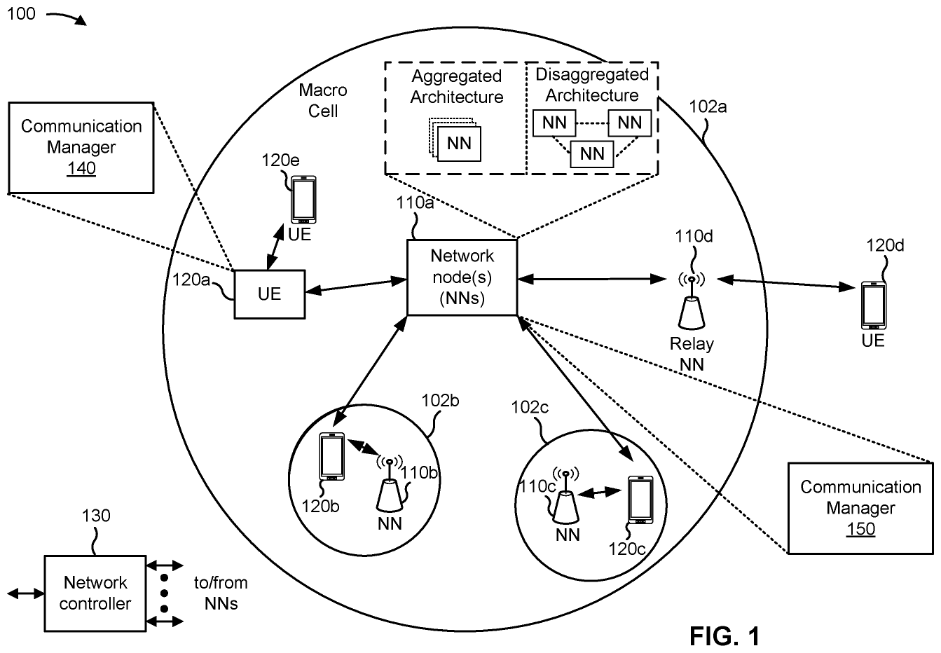

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, an apparatus of a wireless device (e.g., UE 120, network node 110) may include a communication manager 140 or 150. As described in more detail elsewhere herein, the communication manager 140 or 150 may establish a protocol data unit (PDU) session on a bearer. The communication manager 140 or 150 may receive a packet in the PDU session. The communication manager 140 may 140 or 150 may forward the packet based at least in part on whether traffic descriptor (TD) information in the packet matches TD information obtained from traffic policy information. Additionally, or alternatively, the communication manager 140 or 150 may perform one or more other operations described herein.

As indicated above, FIG. 1 is provided as an example. Other examples may differ from what is described with regard to FIG. 1.

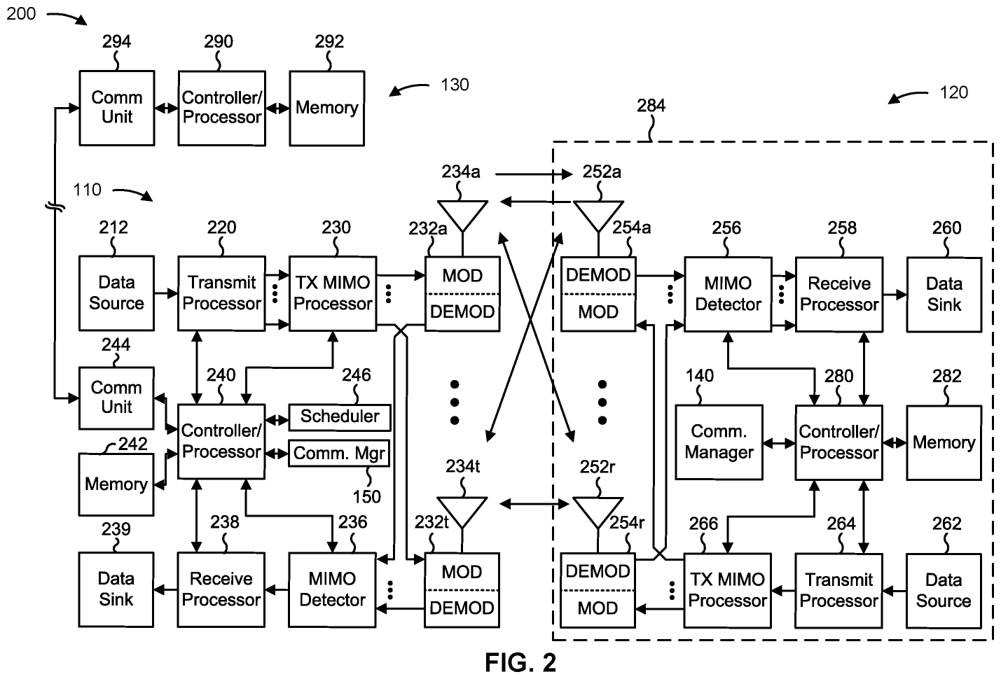

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

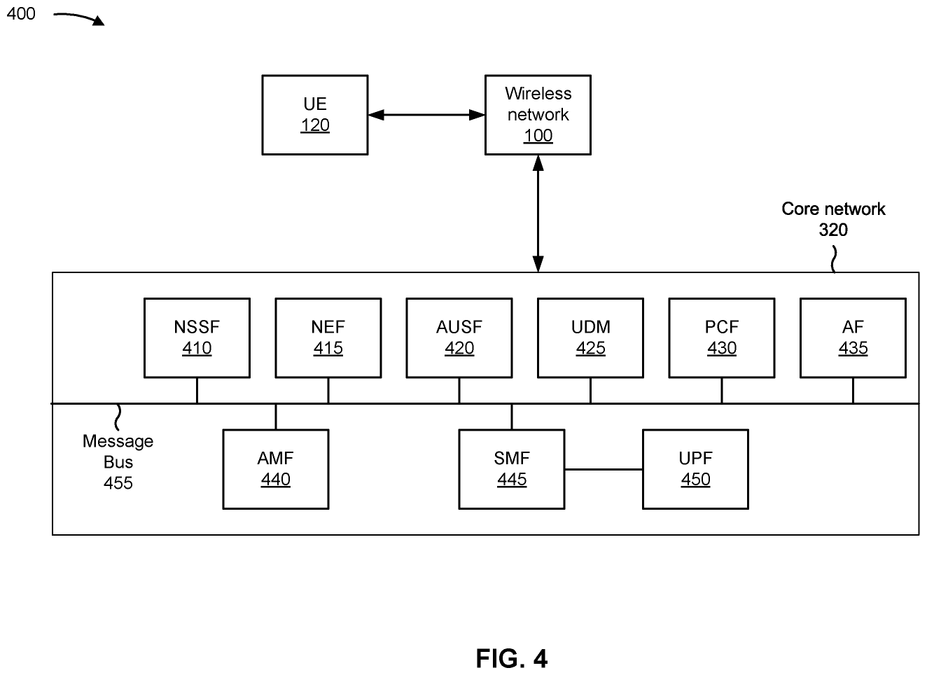

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-9).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-9).

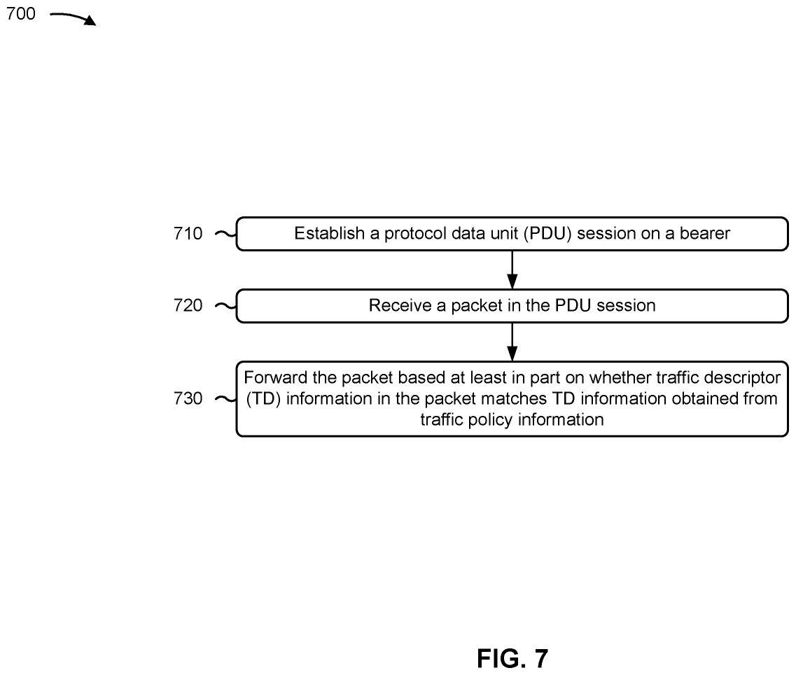

A controller/processor of a network entity (e.g., controller/processor 240 of the network node 110), the controller/processor 280 of the UE 120, and/or any other component(s) of FIG. 2 may perform one or more techniques associated with bearer traffic security enforcement using traffic policy information, as described in more detail elsewhere herein. In some aspects, the wireless device described herein is the network entity, is included in the network entity, or includes one or more components of the network node 110 shown in FIG. 2. In some aspects, the wireless device described herein is the UE 120, is included in the UE 120, or includes one or more components of the UE 120 shown in FIG. 2. For example, the controller/processor 240 of the network node 110, the controller/processor 280 of the UE 120, and/or any other component(s) of FIG. 2 may perform or direct operations of, for example, process 700 of FIG. 7 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7 and/or other processes as described herein. In some examples, executing instructions may include running the instructions, converting the instructions, compiling the instructions, and/or interpreting the instructions, among other examples.

In some aspects, an apparatus of a wireless device (e.g., UE 120, network node 110) includes means for establishing a PDU session on a bearer; means for receiving a packet in the PDU session; and/or means for forwarding the packet based at least in part on whether TD information in the packet matches TD information obtained from traffic policy information. In some aspects, the means for the apparatus to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the apparatus to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

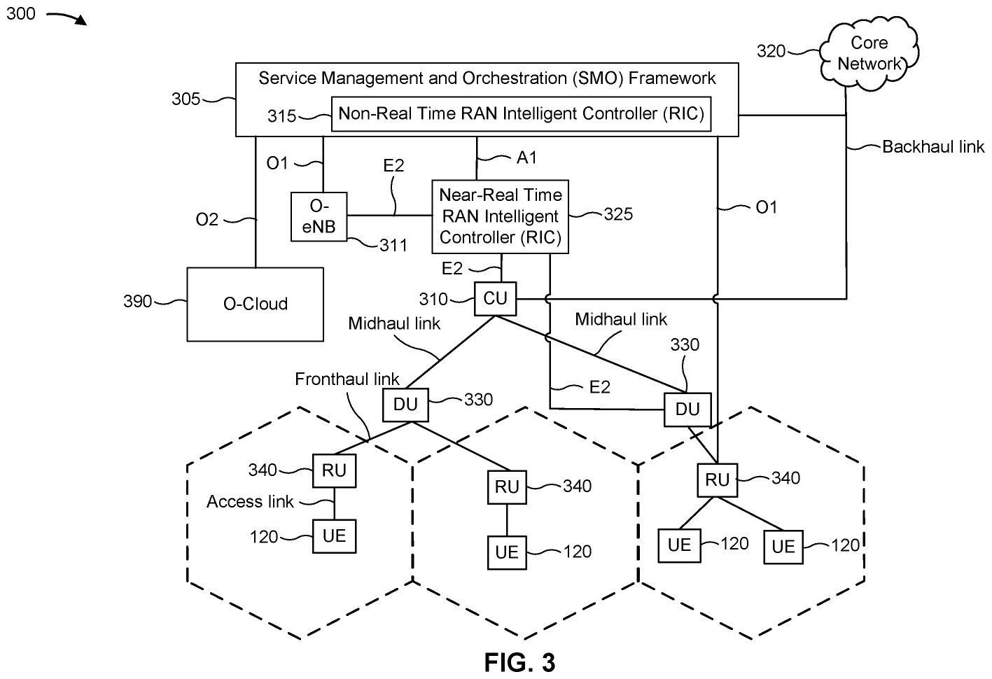

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIG. 4 is a diagram of an example 400 of a core network configured to provide network slicing. As shown in FIG. 4, example 400 may include a UE 120, a wireless network 100, and a core network 320 (such as shown in FIG. 3). Devices and/or networks of example 400 may interconnect via wired connections, wireless connections, or a combination thereof.

The UE 120 may include one or more devices capable of receiving, generating, storing, processing, and/or providing information, such as information described herein. For example, the UE 120 may include a mobile phone (e.g., a smart phone or a radiotelephone, among other examples), a laptop computer, a tablet computer, a desktop computer, a handheld computer, a gaming device, a wearable communication device (e.g., a smart watch or a pair of smart glasses, among other examples), a mobile hotspot device, a fixed wireless access device, customer premises equipment, an autonomous vehicle, or a similar type of device.

The network 100 may support, for example, a cellular RAT. The wireless network 100 may include one or more base stations (e.g., base transceiver stations, radio base stations, node Bs, eNodeBs (eNBs), gNodeBs (gNBs), base station subsystems, cellular sites, cellular towers, access points, TRPs, radio access nodes, macrocell base stations, microcell base stations, picocell base stations, femtocell base stations, or similar types of devices) and other network entities that can support wireless communication for the UE 120. The network 100 may transfer traffic between the UE 120 (e.g., using a cellular RAT), one or more base stations (e.g., using a wireless interface or a backhaul interface, such as a wired backhaul interface), and/or the core network 320. The network 100 may provide one or more cells that cover geographic areas.

In some aspects, the network 100 may perform scheduling and/or resource management for the UE 120 covered by the network 100 (e.g., the UE 120 covered by a cell provided by the network 100). In some aspects, the network 100 may be controlled or coordinated by a network controller, which may perform load balancing and/or network-level configuration, among other examples. As described above in connection with FIG. 1, the network controller may communicate with the network 100 via a wireless or wireline backhaul. In some aspects, the network 100 may include a network controller, a self-organizing network (SON) module or component, or a similar module or component. Accordingly, the network 100 may perform network control, scheduling, and/or network management functions (e.g., for uplink, downlink, and/or sidelink communications of the UE 120 covered by the network 100).

In some aspects, the core network 320 may include an example functional architecture in which systems and/or methods described herein may be implemented. For example, the core network 320 may include an example architecture of a fifth generation (5G) next generation (NG) core network included in a 5G wireless telecommunications system. Although the example architecture of the core network 320 shown in FIG. 4 may be an example of a service-based architecture, in some aspects, the core network 320 may be implemented as a reference-point architecture and/or a 4G core network, among other examples.

As shown in FIG. 4, the core network 320 may include a number of functional elements that are network entities (e.g., network node 110) that are included in network entities or that split functionality with network entities. The functional elements may include, for example, a network slice selection function (NSSF) 410, a network exposure function (NEF) 415, an authentication server function (AUSF) 420, a unified data management (UDM) component 425, a policy control function (PCF) 430, an application function (AF) 435, an access and mobility management function (AMF) 440, a session management function (SMF) 445, and/or a user plane function (UPF) 450, among other examples. These functional elements may be communicatively connected via a message bus 455. Each of the functional elements shown in FIG. 4 may be implemented on one or more devices associated with a wireless telecommunications system. In some implementations, one or more of the functional elements may be implemented on physical devices, such as an access point, a base station, and/or a gateway, among other examples. In some implementations, one or more of the functional elements may be implemented on a computing device of a cloud computing environment.

The NSSF 410 may include one or more devices that select network slice instances for the UE 120. Network slicing is a network architecture model in which logically distinct network slices operate using common network infrastructure. This may include multiplexing virtual and independent logical networks on the same network infrastructure. For example, several network slices may operate as isolated end-to-end networks customized to satisfy different target service standards for different types of applications executed, at least in part, by the UE 120 and/or communications to and from the UE 120. Each network slice may be logically separated but use the same RAN, the same AMF, the same SMF, and the same or different UPFs. Network slicing may efficiently provide communications for different types of services with different service standards. For example, a first network slice may be for V2X applications, a second network slice may be for video streaming for mobile phones, and a third network slice may be for financial applications on mobile phones.

The NSSF 410 may determine a set of network slice policies to be applied at the network 100. For example, the NSSF 410 may apply one or more UE route selection policy (URSP) rules. In some aspects, the NSSF 410 may select a network slice based on a mapping of a data network name (DNN) field included in a route selection description (RSD) to the DNN field included in a traffic descriptor selected by the UE 120. By providing network slicing, the NSSF 410 allows an operator to deploy multiple substantially independent end-to-end networks potentially with the same infrastructure. In some implementations, each slice may be customized for different services. The operator may use a network services orchestrator (NSO) to provision slice services.

The NEF 415 may include one or more devices that support exposure of capabilities and/or events in the wireless telecommunications system to help other entities in the wireless telecommunications system discover network services. The AUSF 420 may include one or more devices that act as an authentication server and support the process of authenticating the UE 120 in the wireless telecommunications system.

The UDM 425 may include one or more devices that store user data and profiles in the wireless telecommunications system. In some aspects, the UDM 425 may be used for fixed access and/or mobile access, among other examples, in the core network 320.

The PCF 430 may include one or more devices that provide a policy framework that incorporates network slicing, roaming, packet processing, and/or mobility management, among other examples. In some aspects, the PCF 430 may include one or more URSP rules used by the NSSF 410 to select network slice instances for the UE 120.

The AF 435 may include one or more devices that support application influence on traffic routing, access to the NEF 415, and/or policy control, among other examples. The AMF 440 may include one or more devices that act as a termination point for non-access stratum (NAS) signaling and/or mobility management, among other examples. In some aspects, the AMF may request the NSSF 410 to select network slice instances for the UE 120, e.g., at least partially in response to a request for data service from the UE 120.

The SMF 445 may include one or more devices that support the establishment, modification, and release of communication sessions in the wireless telecommunications system. For example, the SMF 445 may configure traffic steering policies at the UPF 450 and/or enforce UE internet protocol (IP) address allocation and policies, among other examples. In some aspects, the SMF 445 may provision the network slice instances selected by the NSSF 410 for the UE 120.

The UPF 450 may include one or more devices that serve as an anchor point for intraRAT and/or interRAT mobility. In some aspects, the UPF 450 may apply rules to packets, such as rules pertaining to packet routing, traffic reporting, and/or handling user plane QoS, among other examples.

The message bus 455 may be a logical and/or physical communication structure for communication among the functional elements. Accordingly, the message bus 455 may permit communication between two or more functional elements, whether logically (e.g., using one or more application programming interfaces (APIs), among other examples) and/or physically (e.g., using one or more wired and/or wireless connections).

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of example 400 may perform one or more functions described as being performed by another set of devices of example environment 400.

A UE may use a network slice for an application for communication. The UE may select a PDU session associated with a network slice for the application. A UE may select the PDU session according to a URSP. The URSP may be preconfigured or signaled from a PCF entity to a UE via NAS signaling and/or via an AMF entity.

The UE may provide a registration request. This may include transmitting a single network slice selection assistance information (S-NSSAI) to convey an onboarding request with credentials. The UE may include, in the S-NSSAI, a slice service type (SST) indicator to indicate that the S-NSSAI is for the onboarding with credentials level of access. In some aspects, the SST indicator may be defined (e.g., in a specification) with a value indicating for what the slice is to be used. A network entity may receive the registration request, using an RRC message or an NAS message, and provide an NAS registration message to the AMF to indicate that the S-NSSAI is for the onboarding with credentials level of access. Network slice-specific authentication and authorization (NSSAA) may be triggered based at least in part on the S-NSSAI. The AMF may provide a registration accept message or a registration reject message. If the UE is successfully registered in an S-NSSAI, the UE may transmit a message to the AMF and/or the SMF/UPF to initiate PDU session establishment. For example, the SMF/UPF and the PCF may allow access to a specified IP address or port range for a PDU session established for the UE. The SMF/UPF may provide a PDU session establishment accept message and the UE may, based at least in part on receiving the PDU session establishment accept message, have an IP connection for random access (RA) in a data network.

As indicated above, FIG. 4 is provided as an example. Other examples may differ from what is described with regard to FIG. 4.

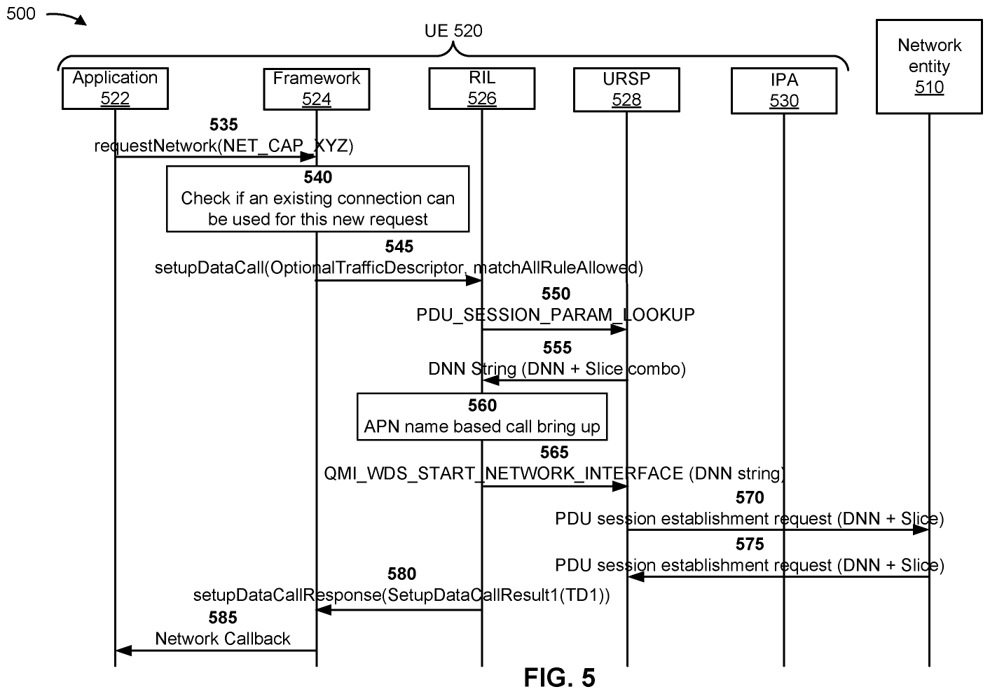

FIG. 5 is a diagram illustrating an example 500 associated with session establishment, in accordance with the present disclosure. As shown in FIG. 5, a network entity 510 (e.g., network node 110) and a UE 520 (e.g., UE 120) may communicate with one another via a wireless network (e.g., wireless network 100). Example 500 shows operations in the control plane and the UE 520 may include an application module 522 that executes an application (e.g., data call) using one or more application processors, a framework module 524 for managing communications, and a radio access layer (RIL) module 526 that controls a modem of the UE 520 that provides an interface to the hardware's radio layer. The UE 520 may include a URSP module 528 that obtains URSP rules and/or TD policy information from a URSP component in the network, and an internet protocol (IP) accelerator (IPA) module 530 in the modem that includes network functions, such as routing, filtering, network address translation, and aggregation, which are performed without active involvement of the main application processor.

When the application module 522 requests for a bearer to be established, the application module 522 may send a request (e.g., requestNetwork) to the framework module 524, as shown by reference number 535. As shown by reference number 540, the framework module 524 may check if an existing connection can be used for this request. If there is an existing connection, the existing connection may be used. If there is no existing connection, the framework module 524 may send a setup data call message to the RIL module 526, as shown by reference number 545, to establish user plane resources for a PDU session associated with a network slice. The setup data call message may include TD information. TD information may include an IP 3 tuple (e.g., destination IP (subnet mask), destination port, protocol identifier ID) and/or standalone TDs, such as an IPv4 remote address type, an IPv6 remote address or prefix length type, a protocol identifier (ID) or next header type, or a single remote port type. The TD information may also include a DNN. TD information may also include an operating system (OS) identifier (ID), an OS application ID, an OS application ID type, a remote port range type, a security parameter index type, a service or traffic class type, a flow label type, a destination MAC address, a destination MAC address type, one or more 812.1Q tags, an ethernet type, connection capabilities, a destination (FQDN), and/or a regular expression.

As shown by reference number 550, the RIL module 526 may send a PDU session parameter lookup message to the URSP module 528. The URSP module 528 may respond with a DNN string (e.g., combination of DNN and network slice information), as shown by reference number 555. As shown by reference number 560, the RIL module 526 may find an access point name (APN) based call to start. As shown by reference number 565, the RIL module 526 may transmit a start network interface message with the DNN string.

The URSP module 528 may try to find the best possible URSP policy (pre-provisioned or indicated over the air) and send out the combination of DNN and network slice information with a profile number to use to start the call. If the profile does not already exist on the modem processor, the RIL module 526 may create a modem profile with the combination provided by the URSP module 528.

As shown by reference number 570, the URSP module 528 may transmit a PDU session establishment request to the network entity 510, with the combination of the DNN and network slice information. As shown by reference number 575, the network entity 510 may transmit a PDU session establishment request, with the combination. As shown by reference number 580, the RIL module 526 may send a setup data call response. As shown by reference number 585, the framework module 524 may transmit a network call back message to the application module 522. That is, the application module 522 module may establish a call using the created profile and PDU session establishment. There is now a PDU session on a bearer for the call.

When a PDU session is established after using the TD from the URSP module 528, there is no way for the UE 520 to determine whether the traffic flowing through the bearer that established the PDU session is still originating from the same intended application (of application module 522) or matches the IP 3 tuple or any other TD's that were defined earlier. For example, an URSP rule (e.g., IP 3 tuple component rule) in a TD is only used to determine if the rule is applicable to a call bring up request. After the PDU session is established, the URSP rules are not used to filter the traffic based on the TD's. That is, there is no traffic enforcement in the modem processor to provide filtering of traffic based on URSP rules. Any traffic that does not match the TD can still proceed on the bearer with the PDU session, which defeats the security purposes of IP 3 tuple TD based PDU establishment. This would impact the user experience and the security for genuine applications (e.g., result in an unresponsive phone) and would involve the unauthorized consumption of the UE 520's signaling resources (e.g., uplink network capacity), processing resources, and memory.

As indicated above, FIG. 5 is provided as an example. Other examples may differ from what is described with regard to FIG. 5.

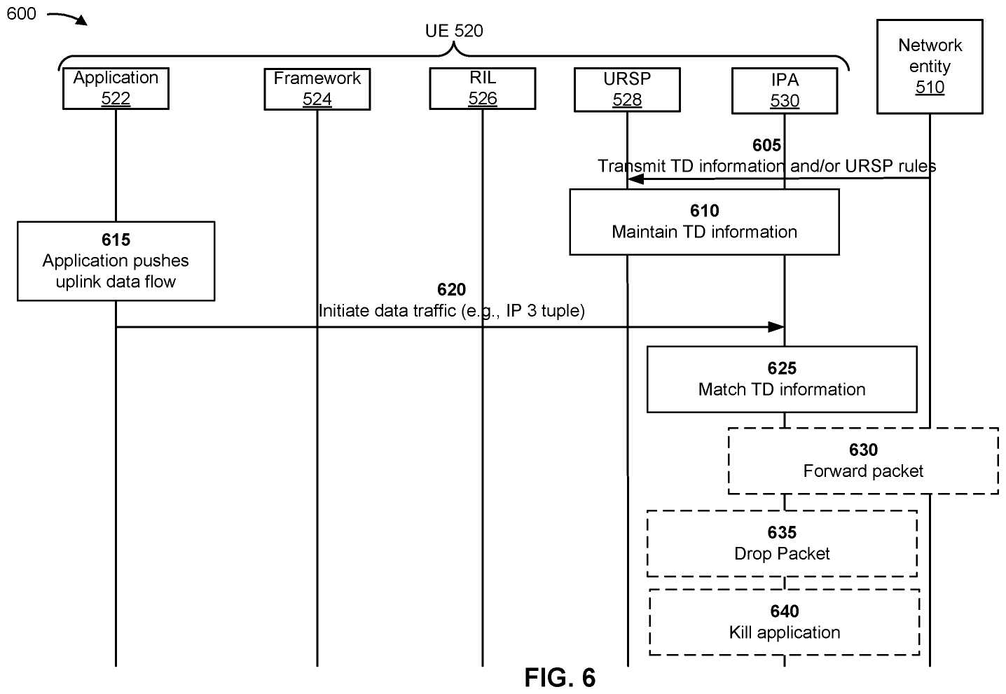

FIG. 6 is a diagram illustrating an example 600 of bearer security, in accordance with the present disclosure. Example 600 shows operations in the user plane, where URSP-based traffic enforcement in the URSP processor provides more secure communications between the UE and the network.

According to various aspects disclosed herein, an apparatus of a wireless device (e.g., UE 120, network node 110) may protect against rogue applications or malware on the application side that can misuse or abuse URSP rules set by an operator and consume resources of the wireless device. The apparatus may operate via a radio interface layer on an application processor, a modem processor, and/or a hardware block. The apparatus may be responsible for IP routing, traffic filtering, and/or mitigating traffic policy violations (e.g., TD information mismatches). The apparatus may operate as a centralized routing module for the wireless device.

The wireless device may establish the PDU session by obtaining a DNN and network slice information, as described in connection with FIG. 5. The wireless device may associate the DNN and the network slice information with the PDU session to form a combination of the DNN, the network slice information, and an ID of the PDU session (PDU session ID). The combination may be associated with a traffic policy that is obtained from the URSP module 528. Once a PDU session is established on a bearer, the apparatus may receive a packet on the bearer and determine whether TD information in the packet matches TD information obtained from traffic policy information (e.g., URSP rules). The TD information may include IP 3 tuple information or other TDs.

Since the TD information is part of the control plane and not part of the packet header or the user plane, the URSP module 528 (e.g., software module in the modem) may send this TD information to the IPA module 530, or the hardware block responsible for a user plane level filtering process. The IPA module 530 may install filtering rules that are based at least in part on TD information received from the URSP module 528.

For example, when a data packet is flowing through the IPA module 530 of the apparatus, the packet header with the IP 3 tuple information may be matched with TD information received from the URSP module 528. If the TD information matches, the packet will be allowed. If any unauthorized application is attempting to send data using the established connection, the packet header will not match the TD information of the URSP module 528 that was used earlier to allow the call to be setup. In some aspects, the IPA module 530 may determine if an application ID of the packet matches an application ID of the authorized application. The IPA module 530 may determine if a source address of the packet matches a source address associated with the authorized application (or application ID). If there is a match, the packet is forwarded.

If the TD information does not match, the packet will not be forwarded. The packet will be dropped at the IPA module 530, or the IPA module 530 may refrain from forwarding the packet. The IPA module 530 may refrain from forwarding the packet in response to degradation of the quality of service (QoS)) of the application and/or a detection of unresponsiveness to forwarded packets. In some aspects, any ports opened by the malicious software will be closed. This can be seen as a kill switch at a master controller. For example, as the modem or IPA module 530 in the modem may be a connectivity center point for such traffic, the IPA module 530, the modem, or the framework module 524 may shut down unauthorized applications to protect the operator domain from unauthorized use of UE 520's signaling resources (e.g., uplink network capacity), processing resources, and memory.

By providing bearer level security for application traffic, the security gap in the data path (not covered in, for example, 3GPP Release 17 technical specification (TS) 23.503) may be closed. In some aspects, this increased security for traffic flows on a bearer may extend beyond URSP rules to other behaviors that protect the UE 520's modem resources, signaling resources, and processing resources. These aspects may also apply to the transmission of packets from applications executing in devices in Wi-Fi networks, devices in WLANs, mobile stations, access points, ultra-wide broadband devices, or other devices in other short-range wireless networks (e.g., Bluetooth® networks).

Example 600 shows an example of a wireless device (e.g., UE 520) using TD information from URSP rules to enforce traffic security. As shown by reference number 605, the network entity 510 may transmit traffic policy information, such as TD information and/or URSP rules that are associated with the TD information. As shown by reference number 610, the URSP module 528 may maintain TD information (e.g., in a database) for matching TD information in received packets. For example, the TD information may include an optional TD or a TD, such as a DNN, an IP 3 tuple, an IPv4 address, a subnet mask, or a protocol ID. The URSP module 528 may send the TD information to the IPA module 530 (e.g., in WDS_REPORT_TD_INFO_IPA).

As shown by reference number 615, the application module 522 may push packets of an uplink data flow, such that the IPA module 530 receives a packet for uplink transmission from the application module 522. As shown by reference number 620 the application module 522 may initiate traffic (packets) towards the IPA module 530. As shown by reference number 625, the IPA module 530 may use logic, machine learning, and/or filtering rules to match TD information in the packet with TD information associated with URSP rules from the URSP module 528. A match may occur if the TD information in the packet has the same value or values as the TD information maintained by the IPA module 530. For example, the values of an IP 3 tuple may be the same, an IPv4 address may be the same, an IPv6 address may be the same, or a combination of DNN and network slice information may be the same. If the values are not the same, a configuration may determine there is a match if a significant amount or threshold amount of information matches or falls within an authorized range.

As shown by reference number 630, if the TD information matches, the packet may be forwarded. This may include forwarding the packet to lower layers for uplink transmission to the network entity 510. The match may apply for one packet or multiple packets. As shown by reference number 635, if the TD information does not match, the packet (or packets) is dropped, or the IPA module 530 may refrain from forwarding the packet. All traffic that is flowing through the IPA module 530 may be forced to undergo filtering based on rules derived from the TD information from the URSP module 528. As shown by reference number 640, based at least in part on information provided by the IPA module 530, the framework module 524 or the modem may kill the application, or terminate one or more processes that are associated with the application.

By matching TD information in packets following an initial call setup, only applications that are authorized to send traffic will be allowed to send traffic to the network entity 510. Any unauthorized software or applications that attempt to use the existing PDU session on the bearer to transfer data to the network entity 510 or other IP addresses may be prevented from doing so. As a result, resource misuse is prevented and processing resources and signaling resources are conserved.

As indicated above, FIG. 6 is provided as an example. Other examples may differ from what is described with respect to FIG. 6.

FIG. 7 is a diagram illustrating an example process 700 performed, for example, by an apparatus of a wireless device, in accordance with the present disclosure. Example process 700 is an example where the apparatus of the wireless device (e.g., UE 120, UE 520, network node 110, network entity 510) performs operations associated with bearer traffic security enforcement.

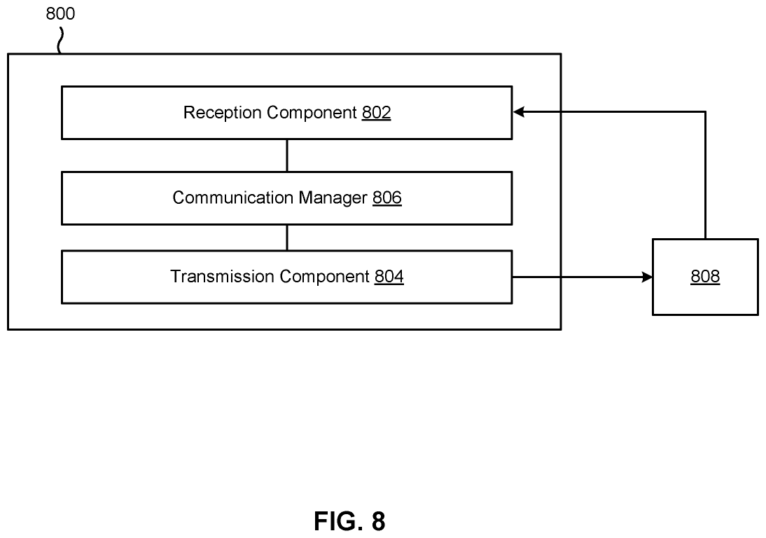

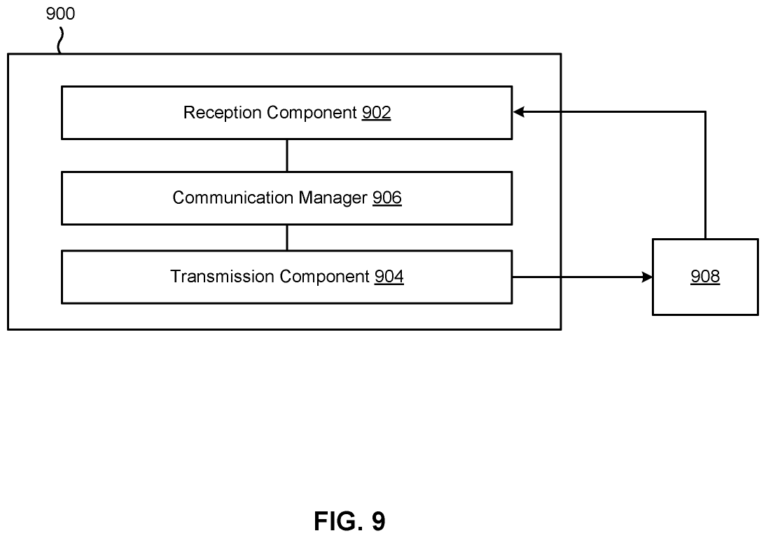

As shown in FIG. 7, in some aspects, process 700 may include establishing a PDU session on a bearer (block 710). For example, the apparatus (e.g., using communication manager 806 depicted in FIG. 8 or communication manager 906 depicted in FIG. 9) may establish a PDU session on a bearer, as described above.

As further shown in FIG. 7, in some aspects, process 700 may include receiving a packet in the PDU session (block 720). For example, the apparatus (e.g., using reception component 802 and/or communication manager 806 depicted in FIG. 8 or reception component 902 and/or communication manager 906 depicted in FIG. 9) may receive a packet in the PDU session, as described above.

As further shown in FIG. 7, in some aspects, process 700 may include forwarding the packet based at least in part on whether TD information in the packet matches TD information obtained from traffic policy information (block 730). For example, the apparatus (e.g., using transmission component 804 and/or communication manager 806 depicted in FIG. 8 or transmission component 904 and/or communication manager 906 depicted in FIG. 9) may forward the packet based at least in part on whether TD information in the packet matches TD information obtained from traffic policy information, as described above.

Process 700 may include additional aspects, such as any single aspect or any combination of aspects described below and/or in connection with one or more other processes described elsewhere herein.

In a first aspect, establishing the PDU session includes obtaining a DNN and network slice information, and process 700 includes associating the DNN and the network slice information with the PDU session to form a combination of the DNN, the network slice information, and a PDU session ID.

In a second aspect, alone or in combination with the first aspect, process 700 includes associating the combination with a traffic policy that is obtained in a control plane message or obtained locally.

In a third aspect, alone or in combination with one or more of the first and second aspects, the TD information of the packet includes one or more of an IP 3 tuple or one or more TDs.

In a fourth aspect, alone or in combination with one or more of the first through third aspects, forwarding the packet based at least in part on whether the TD information in the packet matches the TD information obtained from the traffic policy information includes forwarding the packet based at least in part on the TD information in the packet matching the TD information from the traffic policy information, or refraining from forwarding the packet based at least in part on the TD information in the packet not matching the TD information from the traffic policy information.

In a fifth aspect, alone or in combination with one or more of the first through fourth aspects, refraining from forwarding the packet includes refraining from forwarding the packet based at least in part on a detection of a degradation of a quality of service of an application on the wireless device or a detection of unresponsiveness to forwarded packets.

In a sixth aspect, alone or in combination with one or more of the first through fifth aspects, refraining from forwarding the packet includes refraining from forwarding the packet based at least in part on detecting a policy violation by one or more entities, while the apparatus operates via a radio interface layer on one or more of an application processor, a modem processor, or a hardware block.

In a seventh aspect, alone or in combination with one or more of the first through sixth aspects, the apparatus is responsible for IP routing, traffic filtering, and mitigating traffic policy violations.

In an eighth aspect, alone or in combination with one or more of the first through seventh aspects, process 700 includes shutting down an application associated with the packet based at least in part on the TD information in the packet not matching the TD information obtained from the traffic policy information.

In a ninth aspect, alone or in combination with one or more of the first through eighth aspects, the TD information of the packet includes an application ID, and the forwarding of the packet is further based at least in part on whether the application ID of the packet matches an application ID of the traffic policy information.

In a tenth aspect, alone or in combination with one or more of the first through ninth aspects, the forwarding of the packet is further based at least in part on whether a source address of the packet is associated with an application ID that matches an application ID of the traffic policy information.

In an eleventh aspect, alone or in combination with one or more of the first through tenth aspects, the apparatus is configured to operate as a centralized routing module for the wireless device.

In a twelfth aspect, alone or in combination with one or more of the first through eleventh aspects, the apparatus is configured to run the centralized routing module on an operating system of the wireless device.

In a thirteenth aspect, alone or in combination with one or more of the first through twelfth aspects, process 700 includes receiving the traffic policy information in a signaling message from a network entity.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication, in accordance with the present disclosure. The apparatus 800 may be a UE (e.g., UE 120, UE 520), or a UE may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 140 described in connection with FIG. 1. As shown, the apparatus 800 may communicate with another apparatus 808, such as a UE or a network node (such as a CU, a DU, an RU, or a base station), using the reception component 802 and the transmission component 804.

In some aspects, the apparatus 800 may be configured to perform one or more operations described herein in connection with FIGS. 1-6. Additionally, or alternatively, the apparatus 800 may be configured to perform one or more processes described herein, such as process 700 of FIG. 7. In some aspects, the apparatus 800 and/or one or more components shown in FIG. 8 may include one or more components of the UE described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the UE described in connection with FIG. 2.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 808. In some aspects, the transmission component 804 may include one or more antennas, a modem, a modulator, a transmit MIMO processor, a transmit processor, a controller/processor, a memory, or a combination thereof, of the UE described in connection with FIG. 2. In some aspects, the transmission component 804 may be co-located with the reception component 802 in a transceiver.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

While the examples described in connection with FIGS. 5-8 show secure traffic flow on a bearer from a UE, the aspects described herein may apply to secure traffic flow from a network entity. FIG. 9 is a diagram of an example apparatus 900 for wireless communication, in accordance with the present disclosure. The apparatus 900 may be a network entity (e.g., network node 110, network entity 510), or a network entity may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 150 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 1-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the network entity described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the network entity described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the network entity described in connection with FIG. 2. In some aspects, the transmission component 904 may be co-located with the reception component 902 in a transceiver.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by an apparatus of a wireless device, comprising: establishing a protocol data unit (PDU) session on a bearer; receiving a packet in the PDU session; and forwarding the packet based at least in part on whether traffic descriptor (TD) information in the packet matches TD information obtained from traffic policy information.

Aspect 2: The method of Aspect 1, wherein establishing the PDU session includes obtaining a data network name (DNN) and network slice information, and wherein the method includes associating the DNN and the network slice information with the PDU session to form a combination of the DNN, the network slice information, and an identifier of the PDU session.

Aspect 3: The method of Aspect 2, further comprising associating the combination with a traffic policy that is obtained in a control plane message or obtained locally.

Aspect 4: The method of any of Aspects 1-3, wherein the TD information of the packet includes one or more of an internet protocol (TP) 3 tuple or one or more TDs.

Aspect 5: The method of any of Aspects 1-4, wherein forwarding the packet based at least in part on whether the TD information in the packet matches the TD information obtained from the traffic policy information includes: forwarding the packet based at least in part on the TD information in the packet matching the TD information from the traffic policy information; or refraining from forwarding the packet based at least in part on the TD information in the packet not matching the TD information from the traffic policy information.

Aspect 6: The method of any of Aspects 1-5, wherein refraining from forwarding the packet includes refraining from forwarding the packet based at least in part on a detection of a degradation of a quality of service of an application on the wireless device or a detection of unresponsiveness to forwarded packets.

Aspect 7: The method of any of Aspects 1-6, wherein refraining from forwarding the packet includes refraining from forwarding the packet based at least in part on detecting a policy violation by one or more entities, while the apparatus operates via a radio interface layer on one or more of an application processor, a modem processor, or a hardware block.

Aspect 8: The method of any of Aspects 1-7, wherein the apparatus is responsible for internet protocol routing, traffic filtering, and mitigating traffic policy violations.

Aspect 9: The method of any of Aspects 1-8, further comprising shutting down an application associated with the packet based at least in part on the TD information in the packet not matching the TD information obtained from the traffic policy information.

Aspect 10: The method of any of Aspects 1-9, wherein the TD information of the packet includes an application identifier (ID), and wherein the forwarding of the packet is further based at least in part on whether the application ID of the packet matches an application ID of the traffic policy information.

Aspect 11: The method of any of Aspects 1-10, wherein the forwarding of the packet is further based at least in part on whether a source address of the packet is associated with an application identifier (ID) that matches an application ID of the traffic policy information.

Aspect 12: The method of any of Aspects 1-11, wherein the apparatus is configured to operate as a centralized routing module for the wireless device.

Aspect 13: The method of Aspect 12, wherein the apparatus is configured to run the centralized routing module on an operating system of the wireless device.

Aspect 14: The method of any of Aspects 1-13, further comprising receiving the traffic policy information in a signaling message from a network entity.

Aspect 15: An apparatus for wireless communication at a device, comprising a processor; memory coupled with the processor; and instructions stored in the memory and executable by the processor to cause the apparatus to perform the method of one or more of Aspects 1-14.

Aspect 16: A device for wireless communication, comprising a memory and one or more processors coupled to the memory, the one or more processors configured to perform the method of one or more of Aspects 1-14.

Aspect 17: An apparatus for wireless communication, comprising at least one means for performing the method of one or more of Aspects 1-14.

Aspect 18: A non-transitory computer-readable medium storing code for wireless communication, the code comprising instructions executable by a processor to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus of a wireless device configured for wireless communication, comprising:
a memory; and
one or more processors, coupled to the memory, configured to:
establish a protocol data unit (PDU) session on a bearer;
receive a packet in the PDU session; and
forward the packet based at least in part on whether traffic descriptor (TD) information in the packet matches TD information obtained from traffic policy information.

2. The apparatus of claim 1, wherein the one or more processors, to establish the PDU session, are configured to obtain a data network name (DNN) and network slice information, and wherein the one or more processors are configured to associate the DNN and the network slice information with the PDU session to form a combination of the DNN, the network slice information, and an identifier of the PDU session.

3. The apparatus of claim 2, wherein the one or more processors are configured to associate the combination with a traffic policy that is obtained in a control plane message or obtained locally.

4. The apparatus of claim 1, wherein the TD information of the packet includes one or more of an internet protocol (IP) 3 tuple or one or more TDs.

5. The apparatus of claim 1, wherein the one or more processors, to forward the packet based at least in part on whether the TD information in the packet matches the TD information obtained from the traffic policy information, are configured to:
forward the packet based at least in part on the TD information in the packet matching the TD information from the traffic policy information; or
refrain from forwarding the packet based at least in part on the TD information in the packet not matching the TD information from the traffic policy information.

6. The apparatus of claim 1, wherein the one or more processors, to refrain from forwarding the packet, are configured to refrain from forwarding the packet based at least in part on a detection of a degradation of a quality of service of an application on the wireless device or a detection of unresponsiveness to forwarded packets.

7. The apparatus of claim 1, wherein the one or more processors, to refrain from forwarding the packet, are configured to refrain from forwarding the packet based at least in part on detecting a policy violation by one or more entities, while the apparatus operates via a radio interface layer on one or more of an application processor, a modem processor, or a hardware block.

8. The apparatus of claim 1, wherein the apparatus is responsible for internet protocol routing, traffic filtering, and mitigating traffic policy violations.

9. The apparatus of claim 1, wherein the one or more processors are configured to shut down an application associated with the packet based at least in part on the TD information in the packet not matching the TD information obtained from the traffic policy information.

10. The apparatus of claim 1, wherein the TD information of the packet includes an application identifier (ID), and wherein the one or more processors, to forward the packet, are further based at least in part on whether the application ID of the packet matches an application ID of the traffic policy information.

11. The apparatus of claim 1, wherein the forwarding of the packet is further based at least in part on whether a source address of the packet is associated with an application identifier (ID) that matches an application ID of the traffic policy information.

12. The apparatus of claim 1, wherein the apparatus is configured to operate as a centralized routing module for the wireless device.

13. The apparatus of claim 12, wherein the apparatus is configured to run the centralized routing module on an operating system of the wireless device.

14. The apparatus of claim 1, wherein the one or more processors are configured to receive the traffic policy information in a signaling message from a network entity.

15. A method of wireless communication performed by an apparatus of a wireless device, comprising:
establishing a protocol data unit (PDU) session on a bearer;
receiving a packet in the PDU session; and
forwarding the packet based at least in part on whether traffic descriptor (TD) information in the packet matches TD information obtained from traffic policy information.

16. The method of claim 15, wherein establishing the PDU session includes obtaining a data network name (DNN) and network slice information, and wherein the method includes associating the DNN and the network slice information with the PDU session to form a combination of the DNN, the network slice information, and an identifier of the PDU session.

17. The method of claim 16, further comprising associating the combination with a traffic policy that is obtained in a control plane message or obtained locally.

18. The method of claim 15, wherein the TD information of the packet includes one or more of an internet protocol (IP) 3 tuple or one or more TDs.

19. The method of claim 15, wherein forwarding the packet based at least in part on whether the TD information in the packet matches the TD information obtained from the traffic policy information includes:
forwarding the packet based at least in part on the TD information in the packet matching the TD information from the traffic policy information; or
refraining from forwarding the packet based at least in part on the TD information in the packet not matching the TD information from the traffic policy information.

20. The method of claim 15, wherein refraining from forwarding the packet includes refraining from forwarding the packet based at least in part on a detection of a degradation of a quality of service of an application on the wireless device or a detection of unresponsiveness to forwarded packets.

21. The method of claim 15, wherein refraining from forwarding the packet includes refraining from forwarding the packet based at least in part on detecting a policy violation by one or more entities, while the apparatus operates via a radio interface layer on one or more of an application processor, a modem processor, or a hardware block.

22. The method of claim 15, wherein the apparatus is responsible for internet protocol routing, traffic filtering, and mitigating traffic policy violations.

23. The method of claim 15, further comprising shutting down an application associated with the packet based at least in part on the TD information in the packet not matching the TD information obtained from the traffic policy information.

24. The method of claim 15, wherein the TD information of the packet includes an application identifier (ID), and wherein the forwarding of the packet is further based at least in part on whether the application ID of the packet matches an application ID of the traffic policy information.

25. The method of claim 15, wherein the forwarding of the packet is further based at least in part on whether a source address of the packet is associated with an application identifier (ID) that matches an application ID of the traffic policy information.

26. The method of claim 15, wherein the apparatus is configured to operate as a centralized routing module for the wireless device.

27. The method of claim 26, wherein the apparatus is configured to run the centralized routing module on an operating system of the wireless device.

28. The method of claim 15, further comprising receiving the traffic policy information in a signaling message from a network entity.

29. A non-transitory computer-readable medium storing a set of instructions for wireless communication, the set of instructions comprising:
one or more instructions that, when executed by one or more processors of an apparatus of a wireless device, cause the wireless device to:
establish a protocol data unit (PDU) session on a bearer;
receive a packet in the PDU session; and
forward the packet based at least in part on whether traffic descriptor (TD) information in the packet matches TD information obtained from traffic policy information.

30. An apparatus for wireless communication, comprising:
means for establishing a protocol data unit (PDU) session on a bearer;
means for receiving a packet in the PDU session; and
means for forwarding the packet based at least in part on whether traffic descriptor (TD) information in the packet matches TD information obtained from traffic policy information.
